(19) United States
(12) Patent Application Publication
(10) Pub. No.: US 2007/0004607 A1
(43) Pub. Date: Jan. 4, 2007

(54) Detergent component and process for its preparation

(76) Inventors: Bastiaan Domburg, Vlaardingen (NL); Harmannus Tammes, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/559,645

(22) PCT Filed: May 12, 2004
(86) PCT No.: PCT/EP04/05130

§ 371 Date: Jun. 19, 2006

(30) Foreign Application Priority Data
Jun. 6, 2003 (GB) 0313136.4

(51) Int. Cl. C11D 3/40

(52) U.S. Cl. 510/100

(57) ABSTRACT

A process for the preparation of a granular detergent component comprising an organic superabsorbing material, which process comprises absorbing an aqueous solution, dispersion or emulsion of detergent ingredient on the organic superabsorbing material and removing water by an evaporative process.

### TECHNICAL FIELD

The present invention relates to a granular detergent component suitable for incorporation into particulate laundry detergent compositions, and a novel process for its preparation.

### BACKGROUND AND PRIOR ART

Many detergent ingredients are available in liquid form. This can be for a variety of reasons, for example storage stability.

Detergent surfactants may be available as solids, but in many cases are commercially available only as solutions, generally aqueous solutions of relatively low concentration, typically below 50 wt %, for example, 30 to 40 wt %. For some materials, for example, water-soluble quaternary ammonium cationic surfactants having a single long hydrocarbon chain or branched, especially mid-chain branched anionic surfactants, mobile solutions of higher concentration are not obtainable because gelling occurs. Similarly, complete drying is not effective because the compounds either form sticky solids which are not suitable for handling and processing and/or decompose at the temperatures necessary for effective drying.

Additionally many polymers are available as aqueous solutions and some ingredients are available as emulsions. While these materials may be suitable for inclusion in liquid detergent compositions, or for incorporation in detergent powders via traditional slurry-making and spray-drying processes, the large amount of associated water can pose problems in preparing granular detergent compositions or components by non-spray-drying (mixing and granulation) processes.

WO 96/17042A (Procter & Gamble) discloses detergent granules containing a water-soluble cationic surfactant and an inorganic carrier, the granules also containing an anionic surfactant in a weight ratio to the cationic surfactant of less than 1:1, and preferably less than 0.5:1. The inorganic carrier material is zeolite. The granules are prepared by evaporating and concentrating a solution of the cationic and anionic surfactants to a concentration above 50 wt %, and then granulating with the carrier material. The presence of the anionic surfactant prevents gelling during the concentration step.

WO 98/53037A (Procter & Gamble) discloses a process for the preparation of cationic surfactant granules, in which a aqueous solution or dispersion of cationic surfactant, optionally plus sodium silicate and/or filler, is dried in the presence of a drying gas, preferably air, at a temperature of less than 250° C. The preferred drying method is co-current spray-drying.

The present inventors have now discovered a particularly convenient process for manufacturing detergent components which are made up of liquid ingredients.

The invention accordingly provides a process for the preparation of a granular detergent component comprising an organic superabsorbing material, which process comprises absorbing an aqueous solution, dispersion or emulsion of detergent ingredient on the organic superabsorbing material and removing water by an evaporative process.

In a second aspect, the present invention provides a detergent component comprising an organic superabsorbing material and a detergent ingredient

The detergent component above may be used on its own, but, more commonly, it will be used in conjunction with one or more other ingredients commonly incorporated into detergent compositions. Such components include surfactants not included in the detergent component, including soap, detergency builders, bleach, bleach stabiliser, alkali metal carbonate, sodium silicate, powder structurants, etc. Some or all of these extra components may be incorporated during the process of the present invention, but it is more likely some or all will be combined with the product of the present invention during one or more post dosing processing steps.

The invention is applicable to any detergent ingredient which is supplied as an aqueous solution, e.g. surfactants. It is especially applicable to such ingredients which are sensitive to heat and liable to degradation or decomposition at temperatures above 200° C., or even above 150° C. It is most effective when applied to relatively dilute solutions, where the relatively low ionic strength allows the organic superabsorbent materials to work most effectively, and in particular to solutions which comprise more than 50% water.

### DETAILED DESCRIPTION OF THE INVENTION

The Process

The process of the present invention comprises contacting a sufficient amount of SAP with an aqueous surfactant solution to produce a solid powder and subsequently drying the powder. The SAP may be used in granular form, but this can lead to relatively slow absorption of the surfactant and SAP in powder form is preferred.

The SAP with absorbed surfactant may be dried by any convenient process. Preferably the drying process is chosen to allow for granulation of the SAP/surfactant powder to a size convenient for addition to other components of the final detergent powder. Once dried the granules are hard and non hygroscopic.

The process is capable of producing granules or powder with a high surfactant content, typically up to 90% by weight. Granules or powder with a surfactant content of up to 50% by weight are preferred, with surfactant content of up to 75% by weight most preferred. There is no lower limit to the surfactant content which can be used but the advantages of the invention are not realised below surfactant contents of around 20%, which represents the amount of surfactant which can be absorbed on to standard inorganic builders in detergent compositions. Preferably the surfactant has a minimum level of 40% by weight, more preferably a minimum level of 50% by weight.

The surfactant solution and SAP powder may be brought together by any convenient means. Preferably, the aqueous surfactant is added to the SAP powder in a high, medium or low shear mixer or a flash or thin film evaporator. Most preferably the aqueous solution of surfactant is sprayed on to the SAP powder as it is agitated. In a preferred process the SAP powder, optionally along with other powders, is fluidised in a fluid bed reactor and the surfactant solution sprayed on to or in to the fluid bed. A granular material is formed which may subsequently be dried in the fluid bed or externally. In another preferred process some or all of the surfactant solution is added to the SAP powder, optionally along with other powders, in a high or medium shear mixer or a flash or thin film evaporator before being passed into a fluid bed reactor for addition of extra surfactant solution, if required, and drying.

The SAP powder may conveniently form a proportion of a mixture with builder or filler powder being treated in a granulation process.

The SAP/surfactant component of the invention provides a convenient route for the incorporation into particulate detergent compositions of surfactants which are available only as dilute aqueous solutions. The granules or powder may simply be dry-mixed with other particulate ingredients or components to form the final detergent composition.

As outlined above, the process of the present invention comprises contacting a sufficient amount of SAP with an aqueous surfactant solution to produce a solid powder and subsequently drying the powder. The SAP may be used in granular form. However, the surfactant solutions used may be viscous and penetration of liquid to the centre of a granule can be slow, leading to the use of excess amounts of SAP in the process. This favours SAP particles with a low particle size. Also, the size of the final particle obtained will be governed by the size of the SAP particles in their wet state after absorbtion of water. The lower limit of SAP particle size will be set largely by considerations of handling and dustiness of the dry powder. SAP in powder form is preferred with a maximum median particle size of 200 μm, more preferably 100 μm and most preferably 50 μm. Minimum particle size is preferably 5 μm, more preferably 15 μm.

The surfactant solution and SAP powder may be brought together by any convenient means. SAP particles may be added to aqueous surfactant to form a slurry which is then spray dried. Alternatively, the slurry may be filtered and the filter cake dried by any convenient method or fed as a wet cake to subsequent processing steps. Preferably, the aqueous surfactant is added to the SAP powder in a high, medium or low shear mixer or a flash or thin film evaporator. Most preferably the aqueous solution of surfactant is sprayed on to the SAP powder as it is agitated. The SAP powder may conveniently form a proportion of a mixture with builder or filler powder being treated in a granulation process.

The Mixers

Appropriate mixers for this process include the high-shear Lodige® CB machine or moderate-speed mixers such as a Lodige® KM machine. Other suitable equipment includes Drais® T160 series manufactured by Drais Werke GmbH, Germany; the Littleford mixer with internal chopping blades and turbine-type miller mixer having several blades on an axis of rotation. A low- or high-shear mixer granulator has a stirring action and/or a cutting action which are operated independently of one another. Preferred types of low- or high-shear mixer granulators are mixers of the Fukae® FS-G series; Diosna® V series ex Dierks & Sohne, Germany; Pharma Matrix® ex. T.K. Fielder Ltd, England. Other mixers believed to be suitable for use in the process of the invention are Fuji® VG-C series ex Fuji Sangyo Co., Japan; the Roto® ex Zanchetta & Co. srl, Italy and Schugi® Flexomix granulator.

Yet another suitable mixer is the Lodige (Trade Mark) FM series (ploughshare mixers) batch mixer ex Morton Machine Col Ltd., Scotland.

The low shear mixer may conveniently comprise a gas fluidisation granulator, preferably operated at a superficial air velocity of about 0.1-5.0 ms⁻¹, either under positive or negative relative pressure and with an air inlet temperature ranging from −10° or 5° C. up to 80° C., or in some cases, up to 200° C. An operational temperature inside the bed of from ambient temperature to 60° C. is typical.

In a preferred process the droplet size in the spray relative to the particle size of the solids is adjusted to control granule size, bulk density and the yield of the process. The process comprises spraying droplets of the surfactant solution to contact a particulate solid starting material in a low-shear granulator, wherein the d_{3,2} average droplet diameter (Sauter Mean Diameter) of the liquid binder is not greater than 10 times, preferably not greater than 5 times, more preferably not greater than 2 times and most preferably not greater than the d_{3,2} average particle diameter of that fraction of the total solid starting material which has a d_{3,2} particle diameter of from 20 μm to, 200 μm. If more than 90% by weight of the solid starting material has a d_{3,2} average particle diameter less than 20 μm then the d_{3,2} average particle diameter of the total solid starting material is taken to be 20 μm and if more than 90% by weight of the solid starting material has a d_{3,2} average particle diameter greater than 200 μm then the d_{3,2} average particle diameter of the total solid starting material is taken to be 200 μm.

In order to produce granulates over a range of bulk densities and particle size distribution and having good flow properties the movement of fluidised solids is controlled by controlling the rate of flow of gas used to produce their fluidisation, relative to the rate of application of the surfactant solution. This can be achieved by controlling the ratio of the product of the excess velocity (Uₑ) of the fluidisation gas and the particle density (ρₚ) relative to the mass flux (q_{mliq}) of the liquid as determined at a normalised distance (D₀) of the liquid distribution (spray droplet producing) device.

The process may also be carried out in a flash thin-film evaporator/drier (hereinafter referred to as an “evaporator/drier”). A commercial scale machine typically comprises a large number, at least 300, and preferably at least 1000 blade-like tools mounted on a rotor within a cylindrical chamber. The clearance between the blades and the internal wall of the chamber is low, suitably less than 10 mm or even 5 mm or less. The blade tip speed in operation is suitably ≧15 ms⁻¹, preferably ≧20 ms⁻¹. The ratio of exposed blade length to shaft radius is preferably less than 1, e.g. less than 0.5. Preferably, the large number of blades and the pitch of the blades also means that at least 40%, for example at least 45%, and even substantially the whole chamber wall (that part along the length of the shaft which carries the blades) is scraped during operation.

Initial mixing of the components occurs in the mixing region. The surfactant and SAP are normally fed into the mixing region of the evaporator/drier. However, all or part of either component can be dosed into the drying region. On leaving the mixing region the SAP/surfactant mixture preferably comprises a damp powder, but may comprise a slurry.

The evaporator/drier exerts its drying action by forming a thin layer of material on a heated surface within the drying region. The drying region of the evaporator/drier basically comprises a tube which is substantially circular in cross section and is thus defined by a cylindrical wall. The material entering the drying region is heated. Typically this is achieved by heating the wall of the drying region by means of a heating jacket through which water, steam or oil may be fed.

The drying region may be divided into a number of heating zones, each heated to the same or a different temperature, preferably by means of a respective heating jacket. The temperature in the drying region is preferably maintained at least 100° C., more preferably at least 120° C., yet more preferably at least 130° C.

It has been found to be highly advantageous in the process of the invention to pass the material leaving the drying region of the evaporator/drier through a cooling region. The cooling region may be provided by a separate piece of apparatus, such as for example a cooling fluid bed, an airlift alternatively, may form part of the evaporator/drier apparatus.

The cooling region is preferably operated at a temperature not in excess of 50° C. and more preferably not in excess of temperature 40° C., e.g. 30° C. Actively cooling the particles reduces the possibility of thermal decomposition occurring due to particles being heated to a high temperature. In addition, actively cooling reduces the risk of particles sticking/clumping which may occur when heated particles are allowed to cool passively.

Preferably, the cooling region is defined by a cylindrical wall which is cooled, for example, by a cooling jacket. Where the process is continuous, the evaporator/drier and the cooling region are suitably arranged so that the drying region and cooling region are substantially horizontally aligned to facilitate efficient drying, cooling and transport of the material through the drying region and cooling region in a generally horizontal direction.

In a preferred embodiment, the evaporator/drier apparatus includes the cooling region positioned after the drying region, and the cooling region is a tube which is substantially circular in cross section and is thus defined by a cylindrical wall. When such evaporator/drier apparatus is employed, a suitable temperature gradient is set up going from, for example, at least 100° C. at the inlet end to, for example, not more than 80° C. at the outlet end.

Agitation of the materials in the drying region generally provides efficient heat transfer and facilitates removal of water. Agitation reduces the contact time between the materials and the wall of the drying region, which, together with efficient heat transfer, reduces the likelihood of “hot spots” forming which may lead to thermal decomposition. Moreover, improved drying is secured thus allowing a shorter residence time and increased throughput in the heating zone(s).

Preferably, the cooling region is also provided with agitation means to effect efficient cooling of the material therein. This may be a fluidising gas in a cooling fluid bed. Alternatively, where the cooling region is part of the evaporator/drier apparatus, it is preferred to use the same rotating agitation means as defined above in relation to the drying region.

It will be understood that the cooling region may comprise more than one cooling zone.

In a preferred embodiment, drying and cooling regions together comprise three zones defined by a cylindrical wall, the first two zones being heating zones defining the drying region, and the third zone being the cooling region. Acid precursor and neutralising agent are fed in to the first zone and rotating agitation means comprising a series of radially extending paddles and/or blades mounted on a axially mounted rotatable shaft agitates and transports material through the heating and cooling zones to produce detergent particles.

Preferably, the evaporator/drier is operated at atmospheric pressure in counter-current or co-current with a gas stream. The gas stream may simply be air, which may have been dried so as to reduce its moisture content. The process of the invention is preferably continuous as this facilitate continuous transportation of the particles.

The process of the invention may be carried out in any suitable apparatus. Suitable thin-film evaporator/drier apparatus include the “Flash Dryer/Reactor” manufactured by VRV, the “Turbodryer” manufactured by VOMM and a similar machine available from Bipex Hosokawa.

Any of the above processes may be carried out using surfactant solution and SAP alone. Alternatively, the SAP powder may conveniently form a proportion of a mixture with any other suitable component, preferably a builder or filler powder, which forms part of the final detergent composition. Since most of the processes described above are used to produce granular detergents or detergent components it may well be convenient to produce the detergent component of the present invention in the form of granules. However, if a fine powder is desired process conditions can readily be adjusted to achieve this. A preferred granule produced by the above process has a number average particle size within the range of from 15 to 1500 microns, preferably from 120 to 500 microns.

The Aqueous Solution, Dispersion or Emulsion of Detergent Ingredient

The process of the present invention can be applied to any detergent ingredient which is available in liquid form. For example it can be applied to any surfactant available associated with water as a solvent. It is especially applicable to surfactants which are difficult or impossible to obtain in a solid form suitable for further powder processing. However, it is envisaged that it could be applied to any suitable surfactant to improve its powder handling characteristics. It is likely to find most application in the treatment of anionic, non-ionic and cationic surfactants, which comprise the bulk of the surfactant component of most detergent powder compositions.

Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₂₀ primary alkyl sulphates; alkyl ether sulphates; olefin sulphonates; alkyl xylene sulphonates; dialkyl sulphosuccinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Water-soluble cationic surfactants include quaternary ammonium salts of the general formula R₁R₂R₃R₄N X wherein R₁ is a relatively long (C₈-C₁₈) hydrocarbon chain, typically an alkyl, hydroxyalkyl or ethoxylated alkyl group, optionally interrupted with a heteroatom or an ester or amide group; each of R₂, R₃ and R₄ (which may be the same or different) is a short-chain (C₁-C₃) alkyl or substituted alkyl group; and X is a solubilising anion, for example a chloride, bromide or methosulphate ion. Other classes of cationic surfactant include cationic esters (for example, choline esters).

Zwitterionic surfactants include betaines. An especially preferred material is cocoamidopropyl betaine (CAPB), in which R₆ is C₁₂-C₁₄ alkyl and m is 3.

Preferred amphoteric surfactants include alkyl amine oxides of the general formula R₇R₈R₉N→O wherein R₇ is typically a C₈-C₁₈ alkyl group, for example, C₁₂-C₁₄ alkyl, and R₈ and R₉, which may be the same or different, are C₁-C₃ alkyl or hydroxyalkyl groups, for example, methyl groups. The most preferred amine oxide is coco dimethylamine oxide, in which R₇ is C₁₂-C₁₄ alkyl and R₈ and R₉ are methyl groups.

These lists of surfactants are not intended to be exhaustive and the use of any surfactant suitable for incorporation in particulate laundry detergent compositions and capable of forming an aqueous solution falls within the scope of the present invention.

Other detergent ingredients which are available in liquid form include polymers, antifoams and sequestrants.

Organic Superabsorbent Materials

Organic superabsorbent materials are polymers which have a great affinity for water. Water-absorbing resins are widely used in sanitary goods, hygienic goods, wiping cloths, water-retaining agents, dehydrating agents, sludge coagulants, disposable towels and bath mats, disposable door mats, thickening agents, disposable litter mats for pets, condensation-preventing agents, and release control agents for various chemicals.

Water-absorbing resins are available in a variety of chemical forms, including substituted and unsubstituted natural and synthetic polymers, such as hydrolysis products of starch acrylonitrile graft polymers, carboxymethylcellulose, crosslinked polyacrylates, sulphonated polystyrenes, hydrolysed polyacrylic amides, polyvinyl alcohols, polyethylene oxides, polyvinylpyrrolidones, and polyacrylonitriles.

Such water-absorbing resins are termed “superabsorbent polymers,” or SAPs, and typically are lightly crosslinked hydrophilic polymers. SAPs are generally discussed in Goldman et al. U.S. Pat. Nos. 5,669,894 and 5,599,335. SAPs can differ in their chemical identity, but all SAPs are capable of absorbing and retaining amounts of aqueous fluids equivalent to many times their own weight, even under moderate pressure. For example, SAPs can absorb one hundred times their own weight, or more, of distilled water.

Detergent Compositions

Granular detergent products typically consist of one or more types of granular component, often admixed with one or more post dosed powdered ingredients. Optionally, one or more of the granular components may be sprayed with one or more liquid materials after they have been formed.

Detergent compositions of the invention comprise detergent ingredient and SAP, along with any residual water and/or usual impurities, and may also contain other detergent-active compounds and detergency builders, and may optionally contain bleaching components and other active ingredients, as outlined below, to enhance performance and properties. Any one or more of such other materials may alternatively be incorporated wholly or partly in the granular component of the present invention, with the remaining components supplied in any convenient form. This may comprise one or more other granular components, each containing a single ingredient and/or a mixture of ingredients. Alternatively, one or more of the other ingredients may be post dosed in powder or liquid form. A combination of the two methods may be used.

For some markets a single granular component according to any aspect of the present invention may be sold as a finished product. Alternatively, it may be used in conjunction with other components to produce the finished detergent product. Where a detergent composition according to the invention contains more than one granular component at least one of the granular components must be in accordance with the present invention. Any or all of the other granular components may also be in accordance with the present invention.

Detergent Active Compounds

Detergent-active compounds (surfactants) may be chosen from soap and non-soap anionic, cationic, nonionic, amphoteric and zwitterionic detergent-active compounds, and mixtures thereof. Many suitable detergent-active compounds are available and are fully described in the literature, for example, in “Surface-Active Agents and Detergents”, Volumes I and II, by Schwartz, Perry and Berch. The preferred detergent-active compounds that are used are soaps and synthetic non-soap anionic and nonionic compounds. The total amount of surfactant present is suitably within the range of from 5 to 40 wt %.

Cationic, amphoteric and zwitterionic surfactants may also form part of the surfactant system. They will generally be present in combination with anionic surfactants, the weight ratio of anionic surfactant to cationic, amphoteric or zwitterionic surfactant being at least 1:1.

Detergency Builders

The detergent compositions of the invention also contain one or more detergency builders. The total amount of detergency builder in the compositions will suitably range from 5 to 80 wt %, preferably from 10 to 60 wt %.

Preferred builders are alkali metal aluminosilicates, more especially crystalline alkali metal aluminosilicates (zeolites), preferably in sodium salt form. The compositions of the invention may also contain phosphate builders, for example, sodium tripolyphosphate, either alone or in combination with aluminosilicates.

The aluminosilicate used in most commercial particulate detergent compositions is zeolite A. Advantageously, however, maximum aluminium zeolite P (zeolite MAP) described and claimed in EP-A-384 070 may be used. Zeolite MAP is an alkali metal aluminosilicate of the P type having a silicon to aluminium ratio not exceeding 1.33, preferably not exceeding 1.15, and more preferably not exceeding 1.07.

Zeolite or phosphate builders may suitably be present in a total amount of from 5 to 60 wt %, preferably from 10 to 50 wt %. The zeolites may be supplemented by other inorganic builders, for example, amorphous aluminosilicates, or layered silicates such as SKS-6 ex Clariant.

The zeolites may be supplemented by organic builders, for example, polycarboxylate polymers such as polyacrylates and acrylic/maleic copolymers; monomeric polycarboxylates such as citrates, gluconates, oxydisuccinates, glycerol mono-, di- and trisuccinates, carboxymethyloxysuccinates, carboxymethyloxymalonates, dipicolinates, hydroxyethyliminodiacetates, alkyl- and alkenylmalonates and succinates; and sulphonated fatty acid salts.

Especially preferred organic builders are citrates, suitably used in amounts of from 1 to 30 wt %, preferably from 2 to 15 wt %; and acrylic polymers, more especially acrylic/maleic copolymers, suitably used in amounts of from 0.5 to 15 wt %, preferably from 1 to 10 wt %. Builders, both inorganic and organic, are preferably present in alkali metal salt, especially sodium salt, form.

These lists of builders are not intended to be exhaustive.

Other Components

Detergent compositions according to the invention may also suitably contain a bleach system. Preferably this will include a peroxy bleach compound, for example, an inorganic persalt or an organic peroxyacid, capable of yielding hydrogen peroxide in aqueous solution.

Preferred inorganic persalts are sodium perborate monohydrate and tetrahydrate, and sodium percarbonate, the latter being especially preferred. The sodium percarbonate may have a protective coating against destabilisation by moisture. The peroxy bleach compound is suitably present in an amount of from 5 to 35 wt %, preferably from 10 to 25 wt %.

The peroxy bleach compound may be used in conjunction with a bleach activator (bleach precursor) to improve bleaching action at low wash temperatures. The bleach precursor is suitably present in an amount of from 1 to 8 wt %, preferably from 2 to 5 wt %. Preferred bleach precursors are peroxycarboxylic acid precursors, more especially peracetic acid precursors and peroxybenzoic acid precursors; and peroxycarbonic acid precursors. An especially preferred bleach precursor suitable for use in the present invention is N,N,N′,N′-tetracetyl ethylenediamine (TAED).

A bleach stabiliser (heavy metal sequestrant) may also be present. Suitable bleach stabilisers include ethylenediamine tetraacetate (EDTA), diethylenetriamine pentaacetate (DTPA), ethylenediamine disuccinate (EDDS), and the polyphosphonates such as the Dequests (Trade Mark), ethylenediamine tetramethylene phosphonate (EDTMP) and diethylenetriamine pentamethylene phosphate (DETPMP).

The compositions of the invention may contain alkali metal, preferably sodium, carbonate, in order to increase detergency and ease processing. Sodium carbonate may suitably be present in amounts ranging from 1 to 60 wt %, preferably from 2 to 40 wt %.

Sodium silicate may also be present, suitably in an amount of from 0.1 to 5 wt %.

Powder flow may be improved by the incorporation of a small amount of a powder structurant. Examples of powder structurants, some of which may play also other roles in the formulation, include, for example, fatty acids (or fatty acid soaps), sugars, acrylate or acrylate/maleate polymers, sodium silicate, and dicarboxylic acids (for example, Sokalan (Trade Mark) DCS ex BASF). One preferred powder structurant is fatty acid soap, suitably present in an amount of from 1 to 5 wt %.

Other materials that may be present in detergent compositions of the invention include antiredeposition agents such as cellulosic polymers; soil release agents; anti-dye-transfer agents; fluorescers; inorganic salts such as sodium sulphate; enzymes (proteases, lipases, amylases, cellulases); dyes; coloured speckles; perfumes; and fabric conditioning compounds. This list is not intended to be exhaustive.

Physical Properties of Detergent Compositions

The detergent compositions of the invention are in particulate form. Particulate detergent compositions comprise powders, and tablets of compacted powder.

An important property of detergent powder compositions is bulk density. The SAP/surfactant component may be added to compositions comprising any suitable bulk density. Powders of low to moderate bulk density are commonly prepared by spray-drying a slurry, and optionally postdosing further ingredients by dry-mixing. If such a process is used the SAP/surfactant component of the present invention is added at the postdosing dry mixing stage. “Concentrated” or “compact” powders may be prepared by mixing and granulating processes, for example, using a high-speed mixer/granulator, or other non-tower processes. Such processes may also be adapted to produce low bulk density powders. For all such processes, the SAP/surfactant component may be added at a post dosing dry mixing stage, or may be formed in-situ during a suitable processing stage where SAP and surfactant are combined in the presence of other components of the detergent composition.

### EXAMPLES

### Example 1

A 40.6% active solution of cationic surfactant (Praepagen HY) was contacted with Acusol 771 in a weight ratio of 4.9:1 which resulted in a slurry. Over a few minutes the slurry became an agglomerate of swollen particles due to absorption of the water present.

The swollen particles were dried for 10 minutes in a fluid bed at 80° C. This gave a fine particulate material.

The final composition was about 15% water, 28% absorbent and 57% cationic surfactant. It would be (on complete drying) 34% absorbent 66% cationic surfactant.

### Example 2

Example 1 was repeated but with the surfactant solution and the adsorbent present at a weight ration of 10.1:1. The final composition was about 10% water, 18% absorbent and 72% cationic surfactant. It would be (on complete drying) 20% absorbent 80% cationic surfactant.

### Example 3

A 27% active solution of a polymer was contacted with Acusol 771 in a weight ratio of 4.9:1 which resulted in a slurry. Over a few minutes the slurry became an agglomerate of swollen particles due to absorption of the water present. The swollen particles were dried for 10 minutes in a fluid bed at 80° C. This gave a fine particulate material.

The composition was about 15% water, 36% absorbent and 49% polymer. It would be (on complete drying) 43% absorbent 57% polymer.

### Example 4

A 10% active emulsion of an antifoam (DB110a ex Dow Corning) was contacted with Acusol 771 in a weight ratio of 10:1 which resulted in a slurry. Over a few minutes the slurry became an agglomerate of swollen particles due to absorption of the water present.

The swollen particles were dried for 10 minutes in a fluid bed at 80° C. This gave a fine particulate material.

The composition was about 10% water, 50% absorbent and 40% antifoam. It would be (on complete drying) 56% absorbent 44% polymer.

1. A process for the preparation of a granular detergent component comprising a cross-linked polyacrylate organic superabsorbing material, which process comprises absorbing an aqueous solution of detergent ingredient on the organic superabsorbing material and removing water by an evaporative process, wherein the component comprises at least 40 wt % of a surfactant or mixture of surfactants.

2. A process as claimed in claim 1, wherein the detergent ingredient comprises an anionic surfactant.

3. A process as claimed in claim 1, wherein the detergent ingredient comprises a nonionic surfactant.

4. A process as claimed in claim 1, wherein the detergent ingredient comprises cationic surfactant.

5. A process as claimed in claim 1, wherein the detergent ingredient comprises a polymer.

6. A process as claimed in claim 5, wherein the polymer is amphoteric, nonionic or cationic.

7. A process as claimed in claim 1, wherein the aqueous solution or dispersion of detergent ingredient contains from 20% to 90% by weight of surfactant.

8. A process as claimed in claim 1, wherein the aqueous solution of detergent ingredient and the organic superabsorbent material are mixed in a high shear mixer.

9. A process as claimed in claim 1, wherein the aqueous solution of detergent ingredient and the organic superabsorbent material are mixed in a flash thin film evaporator/dryer.

10. A process as claimed in claim 1, wherein the aqueous solution of detergent ingredient and the organic superabsorbent material are mixed in a low shear mixer.

11. A process as claimed in claim 1, wherein the maximum temperature of the detergent component during the process is 150° C.

12-15. (canceled)
